(19) United States
(12) Patent Application Publication
(10) Pub. No.: US 2024/0029153 A1
(43) Pub. Date: Jan. 25, 2024

(54) Trade and Mobility Data-driven Credit Performance Prediction

(71) Applicant: Windy Hill Pte Ltd, Singapore (SG)

(72) Inventors: Ying Li, Bellevue, WA (US); Joy He-Yueua, Stanford, CA (US); Reza Aghla Ardyan, Bandung City (ID); Vivian Qian Yu Wong, Ann Arbor, MI (US)

(21) Appl. No.: 18/054,556

(22) Filed: Nov. 11, 2022

Related U.S. Application Data
(63) Continuation-in-part of application No. 17/865,582, filed on Jul. 15, 2022.

(51) Int. Cl. G06Q 40/02

(52) U.S. Cl. CPC G06Q 40/025

(57) ABSTRACT

A merchant's mobility data from their mobile device and their purchase history from a wholesale supplier may be used for underwriting a business loan. The mobility data may be analyzed into several descriptive statistics, which may characterize, in a sense, the person's behavior patterns. A merchant's purchase history from a wholesale supplier may be analyzed to estimate several business performance statistics. The estimated performance statistics and the mobility statistics, when combined, may generate an insightful and very accurate profile of a borrower. A machine learning system may use statistics derived from purchasing history as well as mobility information to accurately calculate a confidence score, which may reflect a loan applicant's likelihood of fully repaying a loan. The confidence score may be compared to a threshold value to determine whether to grant or deny a loan. The threshold value may be dynamically updated to meet a loan portfolio's financial objectives.

### CROSS REFERENCE TO RELATED APPLICATIONS

This patent application claims priority to and the benefit of U.S. patent application Ser. No. 17/865,582 entitled “Sparse Data Driven Inventory Intelligence for Optimizing Traditional Trade” filed 15 Jul. 2022, which is expressly incorporated by reference for all it discloses and teaches.

### BACKGROUND

Conventionally, business operations are recorded in a ledger and reported in various reports, such as a cash flow statement, profit and loss statement, and balance sheet reports. These reports summarize a business's health and success, and these reports are used in many transactions as the standardized way of analyzing businesses.

In many cases, however, such reports are either not available or not meaningful. This can happen, for example, with small merchants or businesses run by individuals. Often, smaller businesses do not have rigorous accounting mechanisms, such as automated point of sale systems or the like, or such businesses may be rather informal about their business management.

Such smaller businesses are often kept out of many tools that may help them grow their businesses. One example is credit. With credit, a small merchant may be able to have more inventory, which may lead to higher sales. With credit, the small merchant may be able to grow faster and achieve profitability.

Similarly, larger businesses may keep point of sale records and have more rigorous accounting practices. Even so, cash flow statements, profit and loss statements, balance sheet reports, and other conventional accounting reports show only a limited amount of useful information about a company.

### SUMMARY

A merchant's mobility data from their mobile device and their purchase history from a wholesale supplier may be used for underwriting a business loan. The mobility data may be analyzed into several descriptive statistics, which may characterize, in a sense, the person's behavior patterns. A merchant's purchase history from a wholesale supplier may be analyzed to estimate several business performance statistics. The estimated performance statistics and the mobility statistics, when combined, may generate an insightful and very accurate profile of a borrower. A machine learning system may use statistics derived from purchasing history as well as mobility information to accurately calculate a confidence score, which may reflect a loan applicant's likelihood of fully repaying a loan. The confidence score may be compared to a threshold value to determine whether to grant or deny a loan. The threshold value may be dynamically updated to meet a loan portfolio's financial objectives.

Many factors that may affect a business's performance may be passively collected or inferred, and these factors may be used to analyze a business's creditworthiness, detect fraud, and other uses. The passively collected information may be from monitoring transactions from one of the business's suppliers, from monitoring the business owner's movements through a mobile device, and other sources. The passively collected information may be analyzed to infer several factors that increase the confidence of creditworthiness analyses and serve as a baseline for detecting fraudulent transactions, even when many conventional financial and accounting datapoints may not be known. The passively collected and inferred information may enable a lender to manage a portfolio of loans to small merchants who may not have rigorous accounting practices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a schematic illustration of an embodiment showing an underwriting system using purchase history and mobility information.

FIG. 2 is a diagram illustration of an embodiment showing a network environment with an underwriting system.

FIG. 3 is a flowchart illustration of an embodiment showing a method for analyzing a set of basket features.

FIG. 4 is a flowchart illustration of an embodiment showing a method for gathering and pre-processing mobility data.

FIG. 5 is a flowchart illustration of an embodiment showing a method for an underwriting process.

FIG. 6 is a flowchart illustration of an embodiment showing a method for automatically updating a threshold.

FIG. 7 is a schematic illustration of an embodiment showing a wholesale supplier and retail merchant interaction.

FIG. 8 is a diagram illustration of an embodiment showing a network environment with a supplier system and merchant system.

FIG. 9 is a flowchart illustration of an embodiment showing a method for interaction between a supplier and merchant.

### DETAILED DESCRIPTION

Managing Credit Portfolios with Inferred for Passively Collected Data

Determining the creditworthiness of a business is critical to making loans to such a business. With an accurate and meaningful creditworthiness model, an entire portfolio of loans may be made to businesses.

Many businesses do not have rigorous accounting practices or may not have mechanisms such as point of sale systems, inventory management systems, and other systems to accurately track transactions. Such businesses represent an underserved market of businesses that desperately need assistance to grow. Even when a business has more rigorous accounting practices, the summary reports such as cash flow, profit and loss, and balance statements give only a partial glimpse into the businesses.

Throughout this specification and claims, the term “merchant” may represent a business that may be reviewed for creditworthiness, fraud, or other uses. In the language of this specification, a “supplier” may be a wholesaler to the “merchant,” whereby the “supplier” sells goods, supplies, or services to the “merchant,” who may manufacture or resell various products. The term “merchant” may be the subject business that is being analyzed.

A credit model may evaluate a merchant's creditworthiness by using both express and implied factors. The express factors may include data provided by the merchant, such as their stated business loan amount, business revenue or turnover, and other factors. Many countries have third party services that may provide details about the merchant's credit history, such as the merchant's total debt, number of lenders, amount of debt outstanding, number of late payments, and the like. Payment history for past loans may also be an indicator for creditworthiness.

Implied factors may be derived from sources other than from the borrower directly. In many cases, a supplier to a merchant may have a history of the merchant's purchases. Based on this purchase history, the ‘basket’ of goods purchased by the merchant may be a strong indicator of the merchant's creditworthiness.

The ‘basket’ refers to the group of goods purchased by the merchant from a particular supplier. Several factors may be derived from the basket, such as the concentration of individual products, the product entropy or diversity, the total amount purchased, and other factors. These factors, when compared against other merchants, may be a very strong indicator of creditworthiness.

Additionally, a merchant's mobility gives another strong indicator of creditworthiness. Mobility information may be derived from a cellular phone or other device that travels with the owner of a store. The owner's movements may be tracked, summarized using several statistics, and used as a powerful indicator of the merchant's creditworthiness.

The various features, such as the basket statistics, mobility statistics, as well as self-reported or third-party-reported data may be combined using machine learning techniques to generate a confidence score for a particular loan to a particular merchant. The confidence score may be compared to a threshold to approve or deny a loan.

Portfolio Management

A semi- or fully-automated system may manage a portfolio of loans by adjusting a confidence threshold for new loans added to a portfolio. Applications that are above the threshold may receive funding, while applications below the threshold may be denied.

The threshold may be adjusted dynamically to meet a desired profitability or risk tolerance for the entire portfolio. In every portfolio, there may be some number of loans that may go into default and result in a loss. By adjusting the threshold dynamically, portfolios that may be experiencing a high default rate may adjust the threshold higher, thereby granting loans that are less likely to default. Such an adjustment may grant fewer loans, but may achieve a portfolio's target rate of return.

The dynamic threshold adjustment may be adjusted on a day-by-day or even minute-by-minute basis, thereby approving or denying loans to manage the portfolio's target rate of return.

Features Used in a Machine Learning Model

The various features used in the machine learning model to generate a confidence score have been tested and shown to produce meaningful, reliable, and consistent confidence scores for credit applicants. The model may be created using a training set of previous loans that were successfully repaid, along with other loans that went into default.

It should be noted that the term “features” are parameters, fields, or data that may be used in a machine learning model. A feature may be an individual measurable property or characteristic directly measurable or derived of a merchant, their purchase history, their mobility, and other data relating to the merchant, either directly or indirectly.

For the training data, the features included self-reported information from a merchant, as well as data provided by third parties. Such information may include verifiable data that may compare data supplied by the merchant to the same information available from a third party. Many such features may include

The training data may also include features derived from transaction history. The transaction history may be from a supplier to the merchant. From the supplier's information about the merchant's purchases, several features may be implied, such as the financial value of their baskets of goods purchased, the number of items purchased, the entropy of those items, and many others. In some cases, features such as inventory turnover, warehouse size, and other inventory-related features may be derived from the transaction history.

The training data may include features derived from mobility observations. Mobility observations may be made by capturing a person's movements using their cellular telephones or other mobile devices. Mobility features may include items such as the person's radius of gyration, random entropy of movement, uncorrelated entropy of movement, real entropy of movement, maximum distance travelled, and other derived features.

The modeling performed using such training data has shown considerable improvement in accuracy when compared to standard, conventional human-based underwriting. Human underwriting for loans typically uses actuarial data which considers a much small number of features. Not only has a machine learning model proven itself to be more accurate and reliable than human underwriting, but the ability to dynamically adjust the confidence threshold for approving loans gives a company much more direct control over their portfolio.

Improvement to Computer Systems

The machine learning system for loan underwriting fundamentally changes the function, performance, and usefulness of a conventional computer system. When the machine learning system may operate on a conventional computer, that computer may be transformed into a device that underwrites loans much faster than conventional underwriting and with a much higher accuracy. Further, the device may be transformed into a portfolio management tool that may have dynamically adjustable confidence thresholds that adjusts the portfolio with each loan to meet a desired risk profile and return on investment.

In some cases, portions of the machine learning system may be performed on specialized computer systems. Such systems may have specialized circuitry adapted for machine learning applications, such as hardware for running models of multi-level neural networks for example. Other systems may be specialized for training such neural network models.

Even when the machine learning system operates on a conventional computer system, that conventional computer system is given capabilities that have never been present in a conventional computer system. Such capabilities include the ability to approve or deny loans automatically or with human oversight. In many cases, the machine learning analysis may be performed in a matter of seconds or a small number of minutes, thereby speeding up a process that used to take hours or days to accomplish.

Business Analysis Systems Using Noisy or Incomplete Data

So-called “sophisticated” inventory management systems attempt to manage business operations by the tedious and time-consuming checking in and out of items in inventory. This may occur in warehouses, wholesale suppliers, as well as a merchant's retail store. While generally considered to be the “gold standard” of inventory management, such systems are not infallible. Shrinkage due to spoilage, damage, theft, misplacement, human error, and other problems cause these systems to not have 100% accuracy.

Such systems are often used by business managers to manage inventory, make purchasing decisions, and to monitor sales and profitability. However, most such systems assume 100% accuracy of the data in order to operate effectively.

Many business environments exist where inventory information is not available, incomplete, or where the data are not reliable or accurate.

Many useful business metrics may be inferred or derived from “incomplete” data. These metrics include various general business metrics, such as inventory turnover, as well as individual Stock Keeping Unit (SKU) analyses. Even without tracking both the receipt and sales of an SKU, inferences may be made about the inventory of that SKU based on either just the purchase history or the sales history.

By measuring either receipt or sales of a set of SKUs, general inferences about the business performance may also be made. These inferences, such as adjusted inventory turnover, represent the general performance of a business.

Two Types of Analyses

Two general types of analyses may be performed with a single data set. The data set may be the sales data from one wholesale supplier. This data set may include sales to multiple retail merchants.

From this data set, one set of metrics may be generated to analyze the wholesale supplier's business. These metrics may estimate the supplier's inventory turnover, identify high performing Stock Keeping Units, and other metrics.

Another set of metrics may be generated for the retail merchants who are customers of the wholesale supplier. Similarly, these metrics may include an estimate of the retail merchant's inventory turnover, performance metrics for various SKUs, and other metrics.

In many cases, a retail merchant may purchase wholesale goods from several different wholesale suppliers. In such instances, the estimates of the retail merchant's business metrics may be limited by the SKU data for products purchased from the wholesale supplier. Nonetheless, these metrics may be useful in many ways. including validating the business performance of the merchant, creditworthiness, SKU basket recommendations, and other use cases.

Use Cases for Business Metrics Derived from Incomplete Data

One use case for such derived business metrics may be for smaller merchants that do not have sophisticated inventory management systems. Such merchants might sell in a farmer's market, flea market, or other cash-based or informal retail setting. Other examples may be small, family-run merchants in developing or third world countries where sophisticated point of sale systems are not in widespread use. Many such merchants operate on a cash basis with poor or non-existent accounting systems.

Suppliers to these merchants can monitor the merchant's purchasing behavior and estimate the merchant's relative business performance. A supplier to these merchants may use the derived business metrics in several ways.

In one example, a supplier may offer a dashboard to the merchant that shows the merchant's business performance. This dashboard may give the merchant a running history of their business without any further information provided by the merchant. In some cases, a merchant may be able to provide some data back to the supplier, so that the dashboard may be updated with more accurate information. For example, a merchant may provide periodic inventory data for the number of items on a shelf. This small piece of information may update the inferred inventory levels on the dashboard.

A supplier may be able to offer such a dashboard based on the purchase history of the merchant, without any other source of data. A wholesale supplier may have a system that tracks purchases by their retail merchants, and such data may be sufficient to infer the merchant's performance. By offering such a dashboard, a merchant may be given insights into their business similar to insights from a sophisticated inventory and point of sale system, but without any additional work on their part.

In another example, inferred or derived business metrics may be used for recommending changes to a merchant's SKU “basket,” including recommending higher or lower volumes for specific SKUs, introducing new SKUs, bundling certain SKUs together, and other recommendations.

The inferred performance of individual SKUs may uncover those SKUs that are profitable for a merchant and those that are not as profitable. In many cases with merchants that do not have sophisticated inventory and point of sale systems, merchants may not realize which products they sell are generating the most profits.

A recommended basket of SKUs may add more profitable products for the merchant and suggest removing those SKUs which are less profitable.

Fraud Detection and Creditworthiness

Another use case for business metrics derived from incomplete data may be to identify fraud. Fraud or other abnormalities may happen intentionally or unintentionally in cash-based small businesses, especially when bookkeeping is poor or non-existent.

Fraud or other abnormalities may be detected by comparing derived inventory and business-performance metrics from a different data source and comparing those metrics to data provided by a merchant. When there are large discrepancies, a problem may be indicated, which may prompt an investigation into the issues.

Similarly, derived inventory and business-performance data may be used to determine a merchant's creditworthiness. A supplier, for example, may extend credit to a merchant whose purchasing data can be used to estimate the merchant's adjusted inventory turnover. This and other metrics may be input into a credit analysis to determine how much credit can be extended to the merchant.

Such a creditworthiness evaluation may come from sales data of a supplier, not from the merchant. In many cases, the merchant's books may be requested, but those books may be validated by comparing to inferred or derived business metrics that came from the supplier's records.

Aggregation of Data

The implied or derived business metrics may become more valuable when combined with similar metrics from many suppliers or merchants. In one use case, a wholesale supplier may track the business performance of all their retail merchants to know which merchant is performing well, and which are performing poorly.

A wholesale supplier may give feedback and recommendations to their retail merchants on how to improve sales, such as by changing the SKU mixture being sold, sharing best practices from the high performing merchants, or other improvements.

Improvement to Computer Systems

The recommendation system may be operated on a computer system, and, in some cases, may be implemented using software. It should be noted that when such a recommendation system is implemented on a general-purpose computer system, that the general-purpose computer system is transformed or changed to perform new and different functions than have never been previously performed by such systems. The recommendation system, when implemented on a computer system, changes the behavior and usefulness of the computer system, and the changes create functionality that has not been previously realized from such systems.

The recommendation system may further increase the performance of a general-purpose computer system for business analyses, since the general-purpose computer system may perform business analyses in a less optimal manner prior to implementing the recommendation system.

The analyses performed by a computer system for inventory analyses, SKU recommendations, querying merchants and re-calculating statistics, and other functions described herein become meaningful when performed at scale. Statistics gathered and analyzed for large numbers of SKUs, large numbers of merchants, and large numbers of baskets, when done manually become cumbersome, difficult to perform. Manual calculations lose much of their usefulness because computer systems enable real time or near-real time analyses to be performed, which are not possible if the calculations were done manually.

When done on a computer system, such analyses become nearly instantaneous, making them commercially useful. Without a computer system, such analyses are not commercially valuable because of the time delay of manual calculations and because of the sheer volume of calculations. Recommendation systems may process tens of thousands of transactions a day, with each transaction comprising a thousand SKUs. Such systems, when implemented on a computer, create datasets and analyses that are not possible or commercially practical using manual systems.

Overall Underwriting System

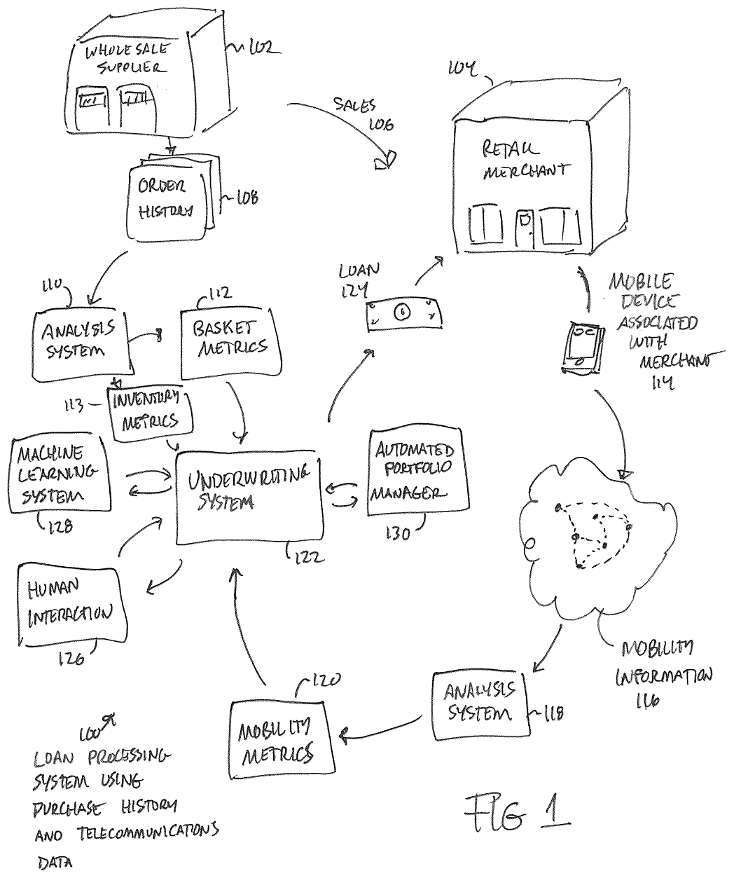

FIG. 1 is a pictorial illustration of an embodiment 100 showing a loan processing system using purchase history and telecommunications data. Embodiment 100 is merely one example of interactions that may effectively and accurately determine a merchant's fitness for a loan. The system may use various implied or derived factors from prior purchases, as well as features derived from a merchant's mobility.

When determining a merchant's suitability for credit, their purchase history may provide rich financial data to an underwriting process. From the purchase history, many implied features, such as estimated inventory turnover, warehouse size, and other features are often far more powerful indicators of a merchant's business health than self-reported data.

Similarly, a merchant's mobility data may also provide information about the merchant's personal habits that may be a rich, insightful, and ultimately powerful set of features for underwriting. In many ways, features derived from purchase history may reflect a business health while features derived from mobility information may reflect the merchant's character and demeanor. Both sets of data may be used to determine whether or not a merchant is suitable for loans.

The underwriting process may use a machine learning system that may be trained on historical data of both good and bad loans. This training set may include features derived from purchase history as well as features derived from telecommunications mobility data.

After training a machine learning model, the resultant neural network or other engine may quickly process a loan request, often in seconds. The result may be a confidence score that reflect the merchant's suitability for a specific loan.

A confidence score may be on a range of 0 to 1, 1 to 100, or some other scale, with one end of the scale denoting high confidence on the merchant's ability to repay a loan.

The confidence score may be compared to a threshold that may be the limit below which no loan will be approved, and above which a loan will be approved. The threshold may be chosen to meet a portfolio goal, such as return on investment, default rate, profitability, or the like. In many systems, an automated system may adjust the threshold up or down, based on data that may be collected about the repayment or default on loans in the portfolio.

A threshold may be lowered thereby allowing more loans to be offered when the portfolio may be performing well and the default rate may be low. By lowering the threshold, loans that are more questionable may be offered. Similarly, if the default rate were climbing and the portfolio's performance was falling, the threshold may be raised to allow loans that were higher quality.

The underwriting algorithm, once properly trained, can very accurately identify the confidence that a loan will perform well and be paid off, or it may identify candidate loans that may enter default. In practice, the algorithm has dramatically outperformed human underwriters in accuracy.

The algorithm has dramatically outperformed human underwriters in speed as well. A well trained computer algorithm can respond to a loan request within seconds, offering or denying the loan virtually instantaneously. The speed gives the lending company a distinct advantage to offer loans on the spot and where desired.

In FIG. 1, a wholesale supplier 102 may do business with a merchant 104. The business may be sales 106 for a merchant's purchases from the supplier 102. The purchases may be stored as an order history 108. An analysis system 110 may generate a set of basket metrics 112 and a set of inventory metrics 113

The basket metrics 112 and inventory metrics 113 may be features derived from the order history 108. The features may include items such as inventory turnover, revenue history, average purchase amount, and other derived statistics.

The merchant 104 may have a mobile device 106 associated with the merchant 104. In a typical situation, the owner of the merchant store may agree to have their mobility tracked for the purposes of credit analysis. The mobile device 106 may typically be a mobile telephone, such as a cellular telephone, although other mobile devices, such as wearable devices, smart watches, and other devices may be used.

A set of mobility information 116 may be generated by the device 114. As the device 114 moves throughout the local area, its movements may be tracked in several different ways. In one manner, an application may operate on the device 114, and, for example, the application may periodically query a Global Positioning System receiver and store the locations in a database.

In another way of tracking, a telecommunications system may log the devices' connectivity to a cell phone tower. The logging may be part of traffic management and communications management on the part of the telecommunications provider. However, these logs may capture sufficient information to derive the device's location over time. A user may give permission for the telecommunications provider to share the location information with an underwriting system.

An analysis system 118 may create a set of mobility metrics 120. The mobility metrics may be summary statistics, such as radius of gyration, random entropy, uncorrelated entropy, real entropy, jump lengths, maximum distance, and other metrics. These metrics may not disclose personal information about the device's user, but the metrics give strong indicators about the user's personal behavior. When used in underwriting loans, these metrics have shown improved performance of the underwriting process.

An underwriting system 122 may take the basket features 112 and mobility metrics 120 to determine whether or not to grant a loan 124 to the merchant 104. In many cases, the underwriting system 122 may be fully automated, yet may have some human interaction 126 to monitor performance. In some cases, the human interaction 126 may include a human underwriter who may grant approval for loans.

The underwriting system 122 may interact with a machine learning system 128. The machine learning system 128 may be trained with a set of training data derived from the performance of previous loans as well as manually curated training data. Once trained, the machine learning system 128 may generate an artificial neural network that may quickly analyze new loans.

The machine learning system 128 may be trained with previous loans for which features corresponding to the basket metrics 112 and mobility metrics 120 have been calculated. Such a system may take into account the various basket metrics 112 and mobility metrics 120 to automatically determine the underwriting results.

The underwriting system 122 may operate in several different manners. In one manner, a loan request may include an amount to borrow. In such a case, the underwriting system 122 may determine whether the loan at that amount may be approved or denied.

In another manner of operating, the underwriting system 122 may determine the maximum loan amount given the merchant's basket metrics 112 and mobility metrics 120. In such a manner of operation, the underwriting system 122 may calculate the loan value that may be approved.

The underwriting system 122 may operate by generating a confidence score for the merchant, the comparing the confidence score with a threshold. The threshold may be the limit above which a loan may be granted and below which the loan may be denied.

An automated portfolio manager 130 may set and adjust the threshold for the underwriting system. When a portfolio of loans is performing poorly, the threshold may be adjusted upward, such that loans with higher confidence of being repaid are being granted. When a portfolio of loans may be performing very well and even exceeding expectations, the automated portfolio manager 130 may adjust the threshold downwards, thereby granting more loans and putting more money in circulation.

The automated portfolio manager 130 may be an automated system that may take into account one or more performance targets for the loan portfolio. Such performance targets may be a target return on investment, a target loss ratio, or other performance metric. The automated portfolio manager 130 may take into account day-by-day and even minute-by-minute changes to the performance of the portfolio. Such changes may occur when a loan may be repaid on time or repaid early. The changes may include when a loan goes into default, when a defaulted loan may be brought current, or when a loan may be liquidated.

Such changes to the portfolio performance may be used in two ways. First, the changes to the status of individual loans may be fed into the machine learning system 128 to update the underwriting model. Additionally, the status of the portfolio as a whole may be instantly updated.

The changes to the portfolio performance may be used to adjust a confidence threshold higher or lower, based on performance of the overall portfolio. Similarly, the changes to individual loans may cause the underwriting algorithm to adjust the confidence calculation for future loans.

In many loan portfolios using such an underwriting system, the loan volume may be very high, in the hundreds, thousands, or tens of thousands of loans as part of a portfolio. Such systems may process tens, hundreds, or even thousands of loan requests per day. In a scenario with such high volumes, an automated portfolio manager 130 may make instantaneous and continuous changes to the threshold to constantly attempt to meet the portfolio performance targets.

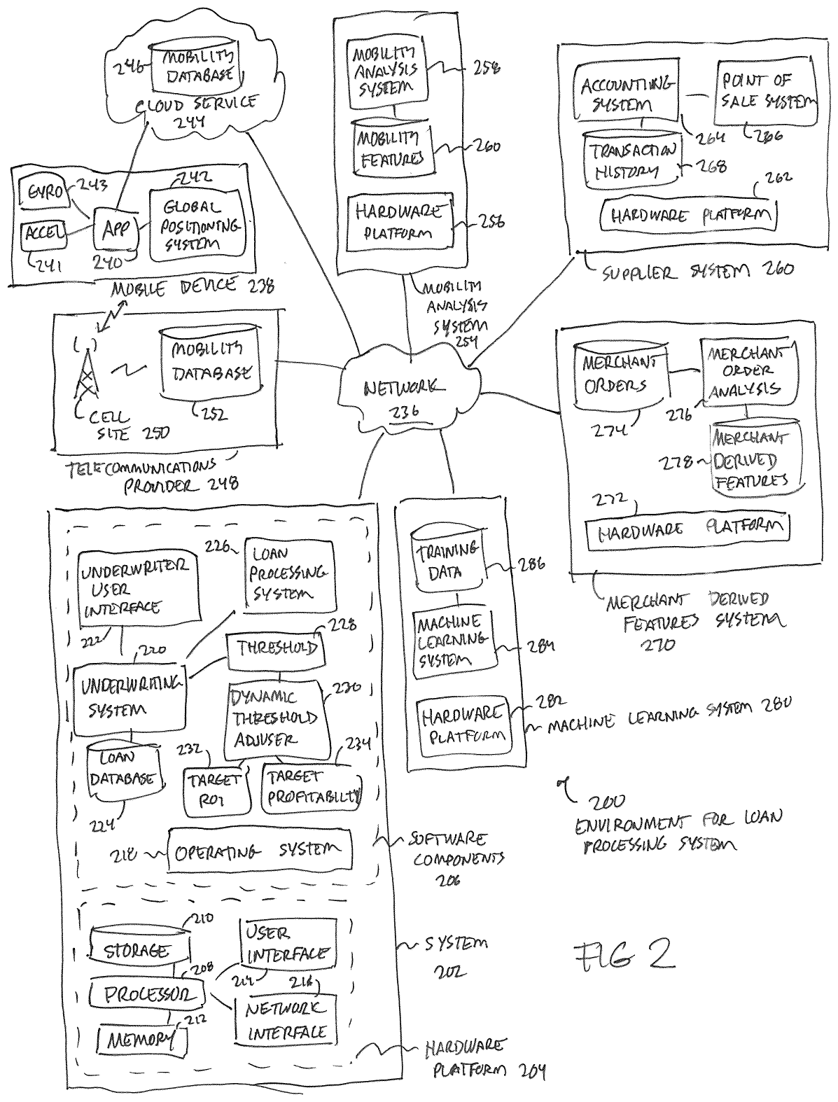

FIG. 2 is a diagram of an embodiment 200 showing components that may perform underwriting for loans using a merchant's purchase history from a supplier, as well as their mobile device location information.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An underwriting system 220 may receive information about a potential loan and process the information to determine a confidence score. A confidence score may be a numerical value that may represent the confidence that the borrower would repay the loan. In some systems, the underwriting system 220 may receive a loan application and may determine the maximum amount of a loan based on a target confidence score.

The underwriting system 220 may include various algorithms. In many cases, calculations involving a potential loan's confidence score may be an artificial neural network algorithm. Such an algorithm may be trained on data that may be curated prior to launch, as well as performance data from loans originated by the underwriting system 220.

In many cases, the underwriting system 220 may have additional algorithms, such as screening rules or other logic that prepares loan data for analysis. Screening rules may be an algorithm that may remove loan applications that do not meet specific criteria. Such rules may have hard parameters that new loans must meet. An example of one such rule may analyze the location of a borrower to ensure that the borrower is in a location where the lender has regulatory authority to issue loans.

Other algorithms may pre-process loan parameters, calculate summary statistics, perform third-party verification of data received from the borrower, or other preparation prior to executing the neural network analysis.

A neural network analysis may, in essence, compare a loan application against all loans in the training set. In a simplified explanation, the comparison may generate a similarity score to those loans considered ‘good’ or desirable. Such a score may be the confidence score that the loan will be repaid in the future.

The underwriting system 220 may operate in a fully automatic mode, where loan applications may be processed very quickly and loan documents prepared and sent to a lender. In such a manner, the underwriting system 220 may operate without human intervention.

An underwriter user interface 222 may perform in several different modes. In one mode, the underwriter user interface 222 may be an administrative user interface where a manager may set up and configure the underwriting system, as well as view reports and statistics from the underwriting system's operations.

In another mode, the underwriter user interface 222 may be a user experience for a human underwriter. In such a mode, the human underwriter may review the underwriting system's recommendations for a loan. In some cases, the loan may not be processed until a human underwriter reviews the loan. In such a case, the underwriting system 220 may generate recommendations, and the human underwriter may have the final approval authority for loans.

The underwriting system 220 may manage a loan database 224 which may include active and completed loans, as well as offers for loans that have not yet been closed. In many cases, the loan database 224 may be used to train an algorithm in the underwriting system 220.

A loan processing system 226 may generate loan documents, receive acceptance from a borrower, set up and receive payments from the borrower, and perform other management of a loan. The loan processing system 226 may be a customer-facing interface through which a borrower manages their loan.

The underwriting system 220 may approve or deny loans based on a threshold 228. The threshold 228 may be a parameter that may be compared to a loan application's confidence score to determine whether or not a loan may be approved or denied. In most systems, a loan that scores below the threshold 228 may be denied, while loans above the threshold 228 may be approved. Other systems may have a numerical value confidence score where lower numbers may reflect greater confidence, and therefore, lower confidence scores may be approved and higher confidence scores denied.

The threshold 228 may be dynamically updated by a dynamic threshold adjuster 230. The dynamic threshold adjuster 230 may receive up to date performance data from loans in a portfolio, then adjust the threshold up or down based on a target return on investment 232, target profitability 234, or other criteria.

The dynamic threshold adjuster 230 may make changes to the threshold 228 on a weekly basis, day-by-day basis, or even minute-by-minute basis. Because the dynamic threshold adjuster 230 may be fully automatic, such a system may monitor incoming payments, default rates, liquidations, and other information about a loan portfolio on a continuous basis. With such information, a new threshold may be calculated with each new incoming piece of data.

It should be noted that it is not practical for a human to adjust the threshold 228 any more often than days, weeks, or even months, especially for high volume loan portfolios. By automating the threshold adjustment, a business manager of a loan portfolio may be able to rapidly adjust or tune the underwriting system 220 to meet targeted financial goals for the portfolio. Such adjustments may be made in real time or near-real time and help keep a portfolio on track.

The system 202 may communicate with other devices through the network 236.

A mobile device 238 may be associated with a borrower for a loan. The mobility data from the device may be used as input to an underwriting system 220 to approve or deny a loan. In some cases, the mobile device 238 may have an application 240 that may gather positional information, such as positional data from a Global Positioning System 242, a gyroscope 243, accelerometer 241, or other sensor. The application 240 may transfer the positional information to a cloud service 244 and store the data in a mobility database 246.

In another system, the mobile device 238 may communicate regularly with various cell sites 250. A telecommunications provider 248 may log the interactions between the mobile device 238 and the cell sites 250 to create a mobility database 252. In many cases, a user may give permission to the telecommunications provider 248 to share their mobility information with an underwriting system.

A mobility analysis system 254 may operate on a hardware platform 256 to process information from one or more of the mobility databases 246 and 252 to generate a set of mobility features 260. Various mobility features may be described elsewhere in this specification.

A borrower's financial transactions may also be used as input to an underwriting system. The borrower's financial transactions may be gathered from a supplier system 260. A supplier may be one of many wholesale suppliers to a merchant. Nonetheless, sufficient information can be obtained from merely one of a merchant's suppliers to determine their creditworthiness.

A supplier system 260 may operate on a hardware platform 262 and may have an accounting system 264, a point of sale system 266, and a database of transaction history 268. The supplier system 260 may capture the wholesale transactions between a wholesale supplier and a retail merchant.

In many cases, a merchant may purchase wholesale products from many different suppliers, but the transaction history 268 may capture only transactions from one supplier to the merchant and not transactions from other suppliers. Even so, the transaction history 268 may be sufficient information for an underwriting system 220 to process a loan application and make an offer for a loan.

One of the reasons why this limited amount of data may be sufficient for underwriting is that the order history for a merchant may reflect a richer set of metrics or features than commonly understood. A merchant derived features system 270 may have a hardware platform 272 on which a database of merchant orders 274 may exist. A merchant order analysis system 276 may process the merchant orders 274 to generate a set of merchant derived features 278. The merchant basket features 278 may be those statistics derived from the purchase history between a supplier and a merchant, as will be discussed elsewhere in this specification. Such features may include basket-related features, inventory-related features, and other features derived at least in part from the merchant orders 274.

A machine learning system 280 may have a hardware platform 282. A machine learning system 284 operating on the hardware platform may process training data 286 to generate a neural network analyzer. Such an analyzer may be one algorithm in the underwriting system 220.

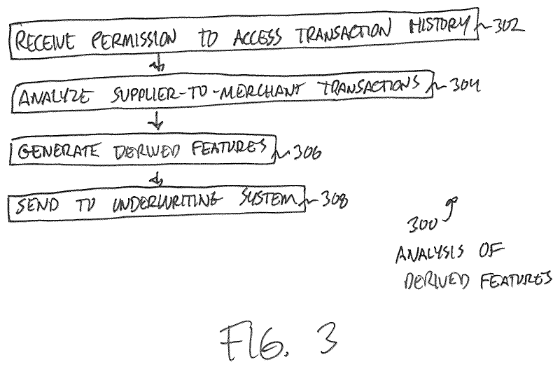

FIG. 3 is a flowchart illustration of an embodiment 300 showing a method of analyzing a set of derived features. Derived features are statistics derived from a set of supplier-to-merchant transactions, where each purchase is a ‘basket’ of items.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

In block 302, permission may be granted by a merchant to access their transaction history. The permission may be granted as part of a request for a loan. In block 304, the supplier-to-merchant transactions may be analyzed to generate a set of derived features in block 306. The features may be sent to an underwriting system in block 308.

Examples of the derived features found to be useful in underwriting loans include the amount of the transaction, total quantity of products purchases, variety of items, entropy of items, diversity of items, the concentration of the most purchased item, and several other statistics or features. Additional items may include the mean sell speed, median sell speed, and maximum sell speed. The sell speed features may be analyzed from one basket to the next, thereby estimating how well the merchant is able to sell their products.

There may be several features that may be derived from multiple transactions. Such features may include all time inventory turnover, last 90 and 30 days inventory turnover, all time revenues, last 90 and 30 days average revenues, mean and median inventory turnover, slope of inventory turnover, mean and median revenues, slope of revenues, mean and median average amount of goods, as well as maximum and slope of amount of goods. Additional features may also be used.

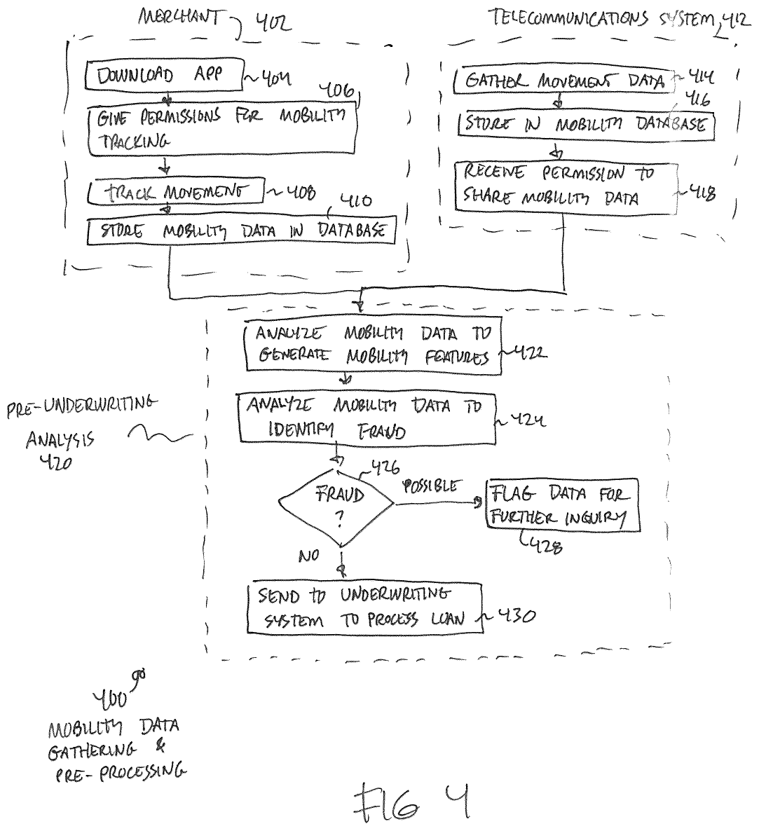

FIG. 4 is a flowchart illustration of an embodiment 400 showing two methods of generating mobility features for use in underwriting loans.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

One method for generating mobility data may be performed by a merchant 402. The merchant 402 may download an application to their mobile device in block 404, then grant the application permission in block 406 to track movement. The movement may be tracked in block 408 and stored in a database in block 410. In many cases, the movement data may be uploaded to a cloud or other remote data either all at once or periodically.

Another method for generating mobility data may be performed by a telecommunications system 412. Telecommunications systems often collect movement data 414 as part of their normal operations, which may be stored in a mobility database in block 416. When the merchant grants permission to the telecommunications system 412 to share the data, the data may be made available.

The mobility data may be analyzed in a pre-underwriting analysis 420 process. The mobility data may be analyzed in block 422 to generate mobility features. Those features may be analyzed in block 424 to identify any fraud. If fraud is found in block 426, the data may be flagged for further inquiry in block 428. If no fraud is found in block 426, the features may be sent to an underwriting system in block 430 to process a loan.

In many cases, mobility data may indicate some sort of fraud may be perpetuated. A fraud detection system may be a machine learning system that has been trained to identify ‘good’ sets of mobility features from ‘bad’ ones.

One type of fraud may be to give a mobile device to someone who is not the merchant. Such a device may show that the device is not at the merchant's store location very much, if at all. Such a discrepancy may indicate a fraudulent set of data has been presented that does not agree with the assumptions of the loan agreement.

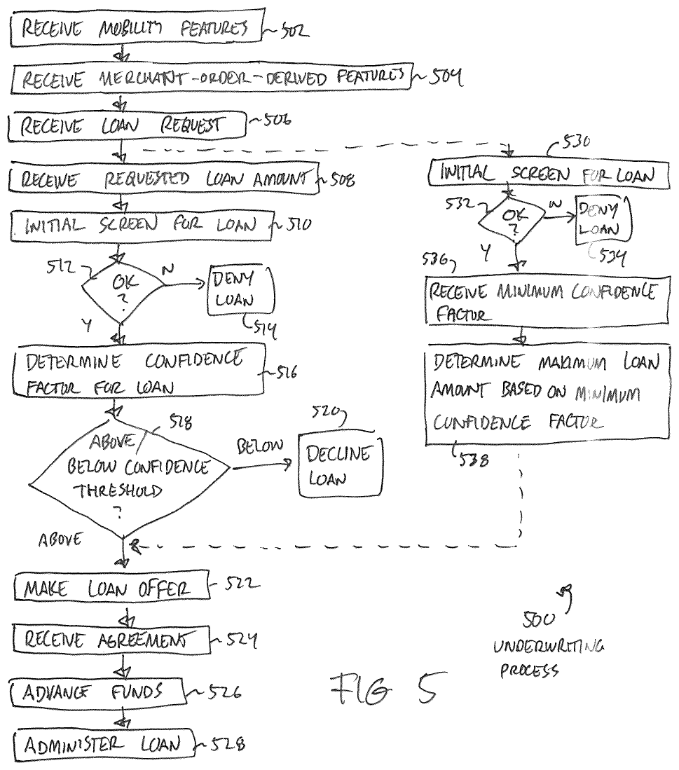

FIG. 5 is a flowchart illustration of an embodiment 500 showing a method for automatically underwriting loans using basket features and mobility features. The method of embodiment 500 may be performed automatically so that loan requests may be nearly instantly processed and funds made available to a borrower very quickly.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Mobility features may be received in block 502, as well as merchant order-derived features in block 504 and the loan request in block 506.

In block 508, a requested loan amount may be received, and an initial screen on the loan may be made in block 510. If the loan request does not pass the initial screen in block 512, the loan may be denied in block 514.

The initial screen may be a set of parameters, rules, or other checks that screens out loans quickly. One example may be to screen out loans that are outside the legal jurisdiction of the lender. Another example may be to screen out borrowers for which there is not enough transaction or mobility data to make a valid analysis. In many cases, the initial screen of block 510 may include various conditions that may be met prior to applying for a loan.

A confidence factor for the loan may be determined in block 516. If the confidence level is below a threshold value in block 518, the loan may be declined in block 520. If the confidence level is above the threshold in block 518, the loan offer may be made in block 522. Once the agreement is signed by a borrower in block 524, the funds may be advanced in block 526 and the loan may be administered in block 528.

Another type of loan analysis may begin in block 530, where an initial screen may be performed. If the loan fails the initial screen in block 532, the loan may be denied in block 534.

This second type of loan analysis may find the maximum loan amount given the current threshold. The current threshold may be defined as the minimum confidence factor that may meet or exceed the threshold in block 536. The maximum loan amount may be determined in block 538, and the loan offer may proceed with block 522.

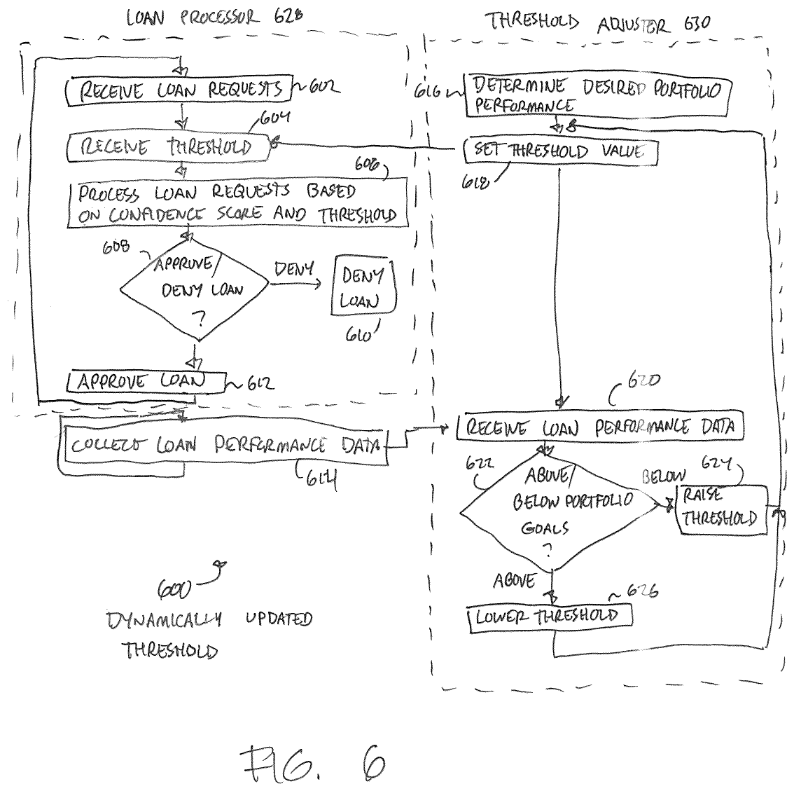

FIG. 6 is a flowchart illustration of an embodiment 600 showing a method of adjusting a threshold based on loan portfolio performance.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Operations of a loan processor 628 include receiving loan requests in block 602 and a current threshold value in block 604. Loan requests may be processed based on the calculated confidence score and current threshold in block 606 to determine if the loan is to be approved or denied in block 608. If denied, the loan may be formally denied in block 610. If approved in block 608, the process may go to block 612 for an approved loan.

Once a loan is in service, loan performance data may be collected in block 614.

Operations of a threshold adjuster 630 may include determining a set of desired performance metrics for the entire portfolio in block 616. From those performance metrics, a threshold value may be set in block 618.

As loan performance data are received in block 620, a determination is made as to whether the portfolio is above or below its goals. If the portfolio is below its financial performance goals in block 622, the threshold may be raised in block 624 to exclude more loans. If the portfolio is performing above its goals in block 622, the threshold may be lowered in block 626 to increase the number of loans. The process may return to block 618 to continue.

Mobility Features

Mobility features are summary statistics that may be derived from location data for a device taken over time. As a device moves throughout a telecommunications system, the device may be transferred from one cell tower to another. In some instances, a Global Positioning System receiver or other location sensor may gather location information periodically. In many cases, location data may be gathered quite frequently, often every few seconds or minutes.

The raw mobility data may be a long series of locations with time stamps. In many systems, the raw data may be summarized into a series of movements between places of dwell or ‘stays.’ Such a summary may reduce thousands or even millions of raw location/timestamp pairs into a manageable number of motions that a user and their device may incur.

Many systems may identify some or all of the stays as meaningful, such as a user's home, their workplace, and other locations. For loan underwriting, the location of a merchant's store may be particularly useful to analyze how much time the merchant spends at their store.

One mechanism to detect fraud may be to test the consistency of data between various sources, such as the merchant's location data and their transactions with a supplier. A fraud detection algorithm may verify that the merchant's device was physically present at a supplier location when the merchant picked up their basket of goods, for example.

Throughout the days, weeks, or months that a merchant and their device may monitored, the merchant may have habits of travel. These habits may be compared to known ‘good’ merchants who are low risks for credit. The mobility data from an unknown merchant applying for a loan may be compared to those merchants with low credit risks to determine whether the new merchant is creditworthy.

Such a comparison may be performed using a machine learning model. Systems that may use both mobility and merchant order-derived features for underwriting may have a single machine learning model that includes both sets of features in the same model. Other systems may have a machine learning model that may operate on the mobility features and a separate machine learning model that may operate on the merchant order-derived features. Such systems may combine the results of the two models to generate a confidence score for a loan.

The mobility features may include tagging locations visited by the merchant's device, such as their home, work, recreation, shopping, suppliers, and other locations. One set of features may include the number of visits and lengths of stays for such locations.

Another feature may be the radius of gyration. The radius of gyration may be computed in kilometers for a user u:

$${r}_{g} ( u ) = \sqrt{\frac{1}{{n}_{u}} {\sum }_{i = 1}^{{n}_{u}} {dist ( {r}_{i} ( u ) - {r}_{cm} ( u ) )}^{2}}$$

where rᵢ(u) represents the nᵤ positions recorded for u, and r_{cm}(u) is the center of mass of u's trajectory. In mobility analysis, the radius of gyration indicates the characteristic distance travelled by u.

The random entropy of users may be defined by:

E_{rand}(u)=log₂(Nᵤ)

where Nᵤ is the number of distinct locations visited by u, capturing the degree of predictability of u's whereabouts if each location is visited with equal probability.

The uncorrelated entropy may be calculated for user u as:

$${E}_{unc} ( u ) = - {\sum }_{j = 1}^{{N}_{u}} {p}_{u} ( j ) {log}_{2} {p}_{u} ( j )$$

where Nᵤ is the number of distinct locations visited by u and pᵤ(j) is the historical probability that a location j was visited by u. The temporal-uncorrelated entropy characterizes the heterogeneity of u's visitation patterns.

The real entropy of an individual u is defined by:

$$E ( u ) = - {\sum }_{{T}_{u}^{′}} P ( {T}_{u}^{′} ) {log}_{2} [ P ( {T}_{u}^{i} ) ]$$

where P(Tᵤ) is the probability of finding a particular time-ordered subsequence T′ᵤ in the trajectory Tᵤ. The real entropy hence depends not only on the frequency of visitation, but also the order in which the nodes were visited and the time spent at each location, thus capturing the full spatiotemporal order present in an u's mobility patterns.

Merchant Order-Derived Features

A set of merchant order-derived features may be used as input for an underwriting system.

A supplier may be capable of monitoring what products may be sold to a merchant. In many cases, a merchant may purchase a “basket” of items periodically. Presumably, the merchant sells the items to their retail customers, however, the supplier may not have access to a merchant's point of sale system. In some cases, a merchant may not have a point of sale system or other mechanism to count each retail transaction.

From the basket of items, certain features of the basket may be computed. These include SKU variety, SKU entropy, SKU diversity, and SKU concentration. These factors may be used to compute the basket consistency and variability over time.

Basket Features

A basket may refer to a collection of SKU items along with the corresponding quantities on an invoice of a purchase transaction. For each basket, the SKU items in the basket generally have the corresponding units and prices.

Given any basket, there are several interesting features that can be calculated. These include SKU variety, SKU entropy, SKU diversity, and SKU concentration. When analyzing baskets over time, basket consistency and basket variability may also be calculated.

Let S be the collection of all SKU items that a system may work with. It is a set, and let N denote the number of distinct SKU's in the collection, |S|=N. B=(s₁, s₂, . . . , sₙ) denotes a basket that contains n SKU items, sᵢ∈S for i=1, 2, . . . , n. B denotes the space of all baskets.

SKU variety for a basket is defined as the number of distinct SKUs in the basket. The distinctness is based on the SKU identity as recorded in a transaction database.

SKU entropy for a basket B={s₁, s₂, . . . , sₙ} is

$$E ( B ) = - {\sum }_{i = 1}^{n} {p}_{i} \times {log}_{2} ( {p}_{i} )$$

where pᵢ is the proportion of SKU item sᵢ in basket B.

SKU diversity for a basket B is defined as the normalized entropy of B. Specifically,

$$D ( B ) = - \frac{{\sum }_{i = 1}^{n} {p}_{i} \times ( {p}_{i} )}{( {\sum }_{i = 1}^{n} I ( {p}_{i} ) )}$$

where I(p) is the unit function.

SKU Concentration is the proportion of total quantities of a SKU item in the basket. If measured over time, e.g., multiple transactions over time, it reflects how a merchant favors certain SKU items or brands. Specifically, for a basket B=(s₁, s₂, . . . , sₙ) with corresponding quantities q=(q₁, q₂, . . . , qₙ), the top-3 concentration is computed as follows:

$$CC ( B , 3 ) = \frac{{\sum }_{i = 1}^{3} {ranked ( q )}_{i}}{{\sum }_{i = 1}^{n} {q}_{i}}$$

To characterize changes in baskets over time, the basket features may be compared over a short period of time and a longer time. For example, a comparison may be made between baskets over a week compared to baskets over a month.

The consistency may be computed as:

$$CS ( M ) = 1 - \sqrt{\frac{{( {D}_{w} - {D}_{m} )}^{2} + {( {CC}_{w} - {CC}_{m} )}^{2}}{2}}$$

where M represents the merchant, D_{w} and Dₘ denotes the SKU diversity over a short period of time and a long period of time, respectively. Similarly, C_{w} and Cₘ represent SKU concentration over short and long time periods, respectively.

Given a collection of baskets B={B₁, B₂, . . . , B_{K}} with associated date of transaction {day₁, day₂, . . . , day_{K}} in chronological order. For each SKU item s in B, let the day gap between baskets that contains SKU item s be g=(g₁, g₂, . . . , gₖ), k≤(K−1) because item s may not appear in all K baskets.

The time variability of SKU item s in the collection of basket B is computed as:

tvb(B,s)=IQR(g)

where IQR stands for inter-quartile range.

The overall time variability of the collection of baskets B can be computed as

IQR(tvb(B,s₁),tvb(B,s₂), . . . ,tvb(B,sₙ))

or

Average(tvb(B,s₁),tvb(B,s₂), . . . ,tvb(B,sₙ))

where {s₁, s₂, . . . , sₙ} are the SKU items in the collection of baskets B.

Given a collection of baskets B={B₁, B₂, . . . , B_{K}}, for each SKU item i in B, let the quantities of SKU item s in all baskets be q=(q₁, q₂, . . . , qₖ), k≤K because item s may not appear in all K baskets.

The quantity variability of SKU item s in the collection of baskets B is computed as

qvb(B,s)=IQR(q)

Given a collection of baskets B={B₁, B₂, . . . , B_{K}}, the overall variability of basket collection B is computed as

$$VB ( B ) = \frac{TVB ( B ) \dot{Q} VB ( B )}{\vert TVB ( B ) \vert \times \vert QVB ( B ) \vert}$$

where

TVB(B)=(tvb(B,s₁),tvb(B,s₂), . . . ,tvb(B,s_{N}))

QVB(B)=(qvb(B,s₁),qvb(B,s₂), . . . ,qvb(B,s_{N}))

for all SKU items in S.

Inventory Turnover Computation

Let S be the collection of all SKU items that our system contains. It is a set, and let N denote the number of distinct SKU's in the collection, |S|=N. Let T be the observation time period, started from t_{b} until t_{f}. I^{T}=(s₁, s₂, . . . , sₙ) denotes an inventory set held by a wholesaler/merchant in the observation period T that contains n SKU items, sᵢ∈S, for i=1, 2, . . . , n. Furthermore, I_{w} and Iₘ denotes an inventory set held by a wholesaler and a merchant respectively.

Sold quantity of a SKU s at time t is denoted as SQₛ^{t} and is computed as

SQₛ^{T}=ΣₜSQₛ^{t}|t∈T

Whereas sold amount of SKU s in the observation time period T, denoted as SAₛ^{T} and is computed as

SAₛ^{T}=SQₛ^{T}×SPₛ^{T}

where SPₛ^{T} is the average selling price for SKU s in T.

The average quantity of SKU s at time t is denoted as AQₛ^{t}. It is computed as

$${AQ}_{s}^{t} = \frac{{BQ}_{s}^{t} + {EQ}_{s}^{t}}{2}$$

where BQₛ^{t} and EQₛ^{t} denote the beginning quantity and ending quantity of SKU s at time t respectively. The average quantity of SKU s in the observation time period T, denoted as AQₛ^{T}, is computed as

AQₛ^{T}=Average{AQₛ^{t}|t∈T,t≥TIₛ^{T}}

where TIₛ^{T} is the initial time SKU s held by the wholesaler in the period T. The average amount of SKU s in the observation time period T, denoted as AAₛ^{T} is obtained by

AAₛ^{T}=AQₛ^{T}×SPₛ^{T}

where SPₛ^{T} is the average selling price for SKU s in T.

Inventory turnover for the wholesaler in the observation time period T, denoted as IT_{w}^{T}, is computed as

$${IT}_{w}^{T} = \frac{{TSA}^{T}}{{TAA}^{T}}$$

where TSA^{T} is the total sold amount of the wholesaler in the period T, computed as

TSA^{T}=ΣₜSAₛ^{T}|t∈I_{w}^{T}

and TAA^{T} is the total average amount of the wholesaler in the period T, computed as

TAA^{T}=ΣₛAAₛ^{T}|s∈I_{w}^{T}

Inventory turnover for each SKU s in I_{w}^{T}, denoted as ITₛ^{T}, can be computed as

$${IT}_{s}^{T} = \frac{{SA}_{s}^{T}}{{AA}_{s}^{T}}$$

Adjusted Inventory Turnover

Inventory turnover is a common measure to assess inventory productivity, to be more precise, by comparing its values across retailers or within themselves over time. However, many studies have showed that utilizing inventory turnover per se for this performance analysis might be not wise, as the values are likely to be influenced several variables of a retailer. It was observed that gross margin, capital intensity, sales surprise, company size, and sales growth rate can be significant in affecting inventory turnover ratios in the retail industry.

In a situation where a supplier has merely its own data of sales to a merchant, a supplier may estimate or approximate inventory turnover using data available to the supplier. In a conventional or classical analysis, a merchant's sales data may accurately measure and calculate inventory turnover.

Many situations exist where a merchant's data may not be available. For example, some merchants may not have a point of sale system or other computerized inventory system. Such merchants may be mom-and-pop retailers, weekend or hobbyist retailers who have informal operations, such as in a flea market or farmer's market. In less developed countries, many merchants, bodegas, restaurants, or other retailers operate without sophisticated inventory tracking systems.

In such cases, suppliers may be able to provide sophisticated business metrics bases on their sales to a merchant. The observations of sales to a merchant, tracked over time, can be used to estimate an adjusted inventory turnover.

Therefore, they suggested to use a new empirical measure, adjusted inventory turnover (AIT), to control the effects of those variables to IT ratios, which lead to a more fair measure for inventory performance comparison.

Business size, denoted as BS, is represented by total amount of sales of in the previous period.

BS^{T}=SA^{T-1}

Sales growth rate, denoted as SG, is computed by comparing current to the previous total amount of sales.

$${SG}^{T} = \frac{{SA}^{T}}{{SA}^{T - 1}}$$

SKU variety, denoted as V, is defined as the number of distinct SKUs held by the wholesaler/merchant in the period T, I^{T}.

SKU diversity, denoted as D, for an inventory set I^{T}=(s₁, s₂, . . . , sₙ) is specified as

$${D}^{T} = - \frac{{\sum }_{i = 1}^{n} {p}_{i} \times {p}_{i}}{( \begin{matrix}{\sum }_{i = 1}^{n} & I ( {p}_{i} )\end{matrix} )}$$

where pᵢ is the proportion of SKU item sᵢ average amount, AAₛ^{T} compared to the total average amount, TAA^{T}·I(⋅) is a unit function.

Warehouse size, denoted as WS, is represented by the total average amount in the given period:

WS^{T}=TAA^{T}

Adjusted Inventory Turnover Model

A log-linear regression model may specify the relationship between variables. Precisely, we use this following log-linear model:

log ITᵢₜ=cₜ+bₜ¹ log BSᵢₜ+bₜ² log SGᵢₜ+bₜ³ log Vᵢₜ+bₜ⁴ log Dᵢₜ+bₜ⁵ log WSᵢₜ+ϵᵢₜ

Where cₜ is the time-specific fixed effect for period T, b¹, b², b³, b⁴, and b⁵ are the time-dependent coefficients for log log B Sᵢₜ, log log S Gᵢₜ, log log Vᵢₜ, log log Dᵢₜ, and log log W Sᵢₜ, respectively. ϵᵢₜ is the error term between the observation to the model.

This equation provides a tradeoff curve between the expected inventory turnover of a wholesaler/merchant for their values of those control variables.

The adjusted inventory turnover may be computed as,

log AITᵢₜ=log ITᵢₜ−bₜ¹ log BSᵢₜ−bₜ² log SGᵢₜ−bₜ³ log Vᵢₜ−bₜ⁴ log Dᵢₜ−bₜ⁵ log WSᵢₜ

or

AITᵢₜ=ITᵢₜ(BSᵢₜ)^{-b}^{ₜ}^{¹}(SGᵢₜ)^{-b}^{ₜ}^{²}(Vᵢₜ)^{-b}^{ₜ}^{³}(Dᵢₜ)^{-b}^{ₜ}^{⁴}(WSᵢₜ)^{-b}^{ₜ}^{⁵}

This adjusted value can then be utilized as a measure for inventory performance comparison, either across wholesalers/merchants or across periods by controlling the values of the control variables.

The equation for the Adjusted Inventory Turnover reflects an estimated business performance based on the factors that a supplier can readily measure. Because the supplier does not have access to a merchant's point of sale system or a merchant may not even maintain a point of sale system, the supplier may, nonetheless, be able to monitor the merchant's business performance.

Wholesale Supplier's Inventory Turnover Computation

A wholesale supplier's inventory turnover computation may be made by creating a simulation based on observed sales, then optimizing the simulation to determine estimated or approximate values for inventory turnover.

For SKUs, osq is an array to store the sold quantity for each time index t, as:

osq={osq_{{1}},osq_{{2}}, . . . ,osq_{{(T)}}}

where T is the length of the period.

The inventory may be simulated by following a (s, S) inventory policy, where s is the reorder level and S is the target inventory level. Under this policy, an order to replenish the stock is placed when the inventory level has reached or below s, so that the inventory level would reach S again. The simulation may use an initial quantity of the SKU, IQ, and the lead time, LT, which describes how many days the stock would arrive after the order was placed.

Given the simulation parameters, the beginning inventory level and ending inventory level at each t can be estimated. Each inventory level, that is stored in bq and eq respectively, as:

bq is an array to store the beginning quantity at each t as:

bq={bq_{{1}},bq_{{2}}, . . . ,bq_{{T}}}

Similarly, eq is an array to store the ending quantity at each t as:

eq={eq_{1},eq_{2}, . . . ,eq_{T}}

where T is the length of the period.

The estimated values of bq and eq may be acquired by running a simulation where the input data are the array osq and parameters s, S, IQ, and LT. The output are the arrays bq and eq.

For each time period, bq and eq may be updated to subtract any sales from the current time period. If the inventory falls at or below s, the inventory is replenished to S.

The result is a sequence of bq and eq arrays that simulates the inventory levels over each instance of time. A constrained optimization analysis using the recorded transaction data SQ. The optimization problem can be defined as:

```
      S
s.t. eq_{t} ≥ 0 | t ϵ T
    s = k × S
    IQ = S
  LT = LT_{arb}
```

The optimization problem may be done to find the lowest values of S, while satisfying the recorded transaction data, i.e., there are no negative values of ending inventory level. The problem may be defined by assuming the wholesaler would have the lowest possible target inventory level S, as for their limited warehouse size and storage cost. Moreover, there are also arbitrary parameters to control the optimization: k is the proportion of s to S, and LTarb is a defined arbitrary lead time.

These parameters are chosen to approximate the actual inventory levels and lead time appropriate for the business. Typically, such parameters may be based on observations of the actual business.

The analysis above assumes that there is no shrinkage, stolen items, mis-entered data, or other problems. Even with modern point of sale systems, there are transactions that may not be captured. The mathematical model may be configured to learn from unobserved sales and inventory losses when given transactions and inventory level updates.

Inventory may be physically counted at various intervals for each SKU. These updates may be stored in an array q as well as a time of the update, t.

q_{{u}}={q_{{u,1}},q_{{u,2}}, . . . ,q_{{u,m}}}

t_{{u}}={t_{{u,1}},t_{{u,2}}, . . . ,t_{{u,M}}}

where M is the number of inventory updates.

Unobserved sales and inventory losses can be explained by US and IL random variable, respectively. Random variable is used since it may be likely that relatively few inventory updates may be available.

Unobserved sales may be a truncated normal distribution that is related to the observed sales. A part of the analysis assumes that inventory values may not be negative.

The random unobserved sales US may be defined as

US=0≤N(μ_{{us}},σ_{{us}})≤(bq−osq)

where μ_{{us}} and σ_{{us}} may be mean and standard deviation of the distribution, respectively.

μ_{{us}}=C_{{1}}×sq+c_{{2}}

where c1 represents the expected proportion of unobserved sales to the observed sales. c2 is an intercept parameter used to allow the occurrence of unobserved sales even when there are no recorded transactions. Assuming the distribution has a constant coefficient of variance across input spaces, σ_{{us}} can be defined as:

σ_{{us}}=CV_{{us}}×μ_{{us}}

where CVus is the constant coefficient of variance for the distribution.

Inventory losses IL is specified as a Bernoulli distribution in some cases. Inventory losses may be defined as:

IL=B(λ)×c₃×(bq−osq−usq)

where λ is the probability of the inventory loss occurring and c3 is the proportion of the inventory loss to the current inventory level, which is the beginning inventor level minus the observed and unobserved sales.

Similar to the previous simulation, the beginning and ending inventory levels may be estimated by running a similar simulation, but with random variables US and IL. The beginning and ending inventory levels may also be in the form of random distributions.

Such a simulation may have two types of parameters. One type are the simulation parameters such as the target inventory level S, reorder inventory level s, and initial inventory level IQ. The second type may be the random variables c1, c2, cv, c3, and λ. In order to estimate these variables, a constrained multi-objective optimization may be performed using recorded data sq and updated inventory level data q.

The optimization problem may be defined as:

```
    S
  L(qᵤ , eq)
s.t. eq_{t} ≥ 0 | t ϵ T
  s = k × S
  IQ = q_{u,1}
```

Here, the optimization may be performed to minimize the target stock S while satisfying the recorded data. An objective function maximizes the likelihood of simulated inventory levels to the received actual inventory level updates L(qu, eq). The optimized parameters may generate the most likely simulated inventory levels in explaining transaction and updated inventory levels data.

A parameter CVqu may represent the inaccuracy of the inventory level updates. The likelihood may be evaluated on a distribution as L(N(qᵤ, CV_{qu}qᵤ), eq).

Using the optimal parameters and the updated inventory levels data, the simulated inventory levels may be inferred. This can be achieved by performing a large number of simulations, then finding the simulations that best match the distribution of actual inventory levels, N(qᵤ, CV_{qu}qᵤ).

Further, simulated inventory levels before and after the last inventory level updates within a period. These inventory levels may be later used for inventory turnover computation. This gives the total estimated sold quantities by adding the observed and unobserved sold quantities.

Inventory Turnover Computation.

Computing inventory turnover for each SKU can be done with the estimated values of beginning and ending inventory of each time period, which is often one day.

An array may store the selling amounts

sa={sa_{{1}},sa_{{2}}, . . . ,sa_{{T}}}

saᵢ=sqᵢ×spᵢ

where sp is the selling price of a SKU.

ba may be an array to store the beginning amounts

ba={ba_{{1}},ba_{{2}}, . . . ,ba_{{T}}}

baᵢ=bqᵢ×spᵢ

ea may be an array to store the ending amounts

ea={ea_{{1}},ea_{{2}}, . . . ,ea_{{T}}}

eaᵢ=eqᵢ×spᵢ

The average amount held by a wholesale supplier for each SKU, AA can be computed as

$$aa = \{ {aa}_{\{ 1 \}} , {aa}_{\{ 2 \}} , … , {aa}_{\{ T \}} \} \\ {aa}_{i} = \frac{{bq}_{i} + {sa}_{i}}{2}$$

The average amount held by the wholesaler during a period, AA may be computed by averaging the values in aa as

$$AA = \frac{{\sum }_{i}^{T} {ee}_{i}}{T}$$

The total sold amounts for each SKU by the wholesaler, SA may be

$$SA = {\sum }_{i}^{T} {sa}_{i}$$

Inventory turnover IT may be defined as

$$IT = \frac{SA}{AA}$$

The overall inventory turnover for the wholesaler may be computed by summing all SKUs.

Throughout this specification and claims, the term “supplier” is used to denote a wholesale supplier of goods. The term “merchant” is used to denote the retail seller of goods. A “supplier” sells goods to a “merchant,” who then sells the goods to a consumer.

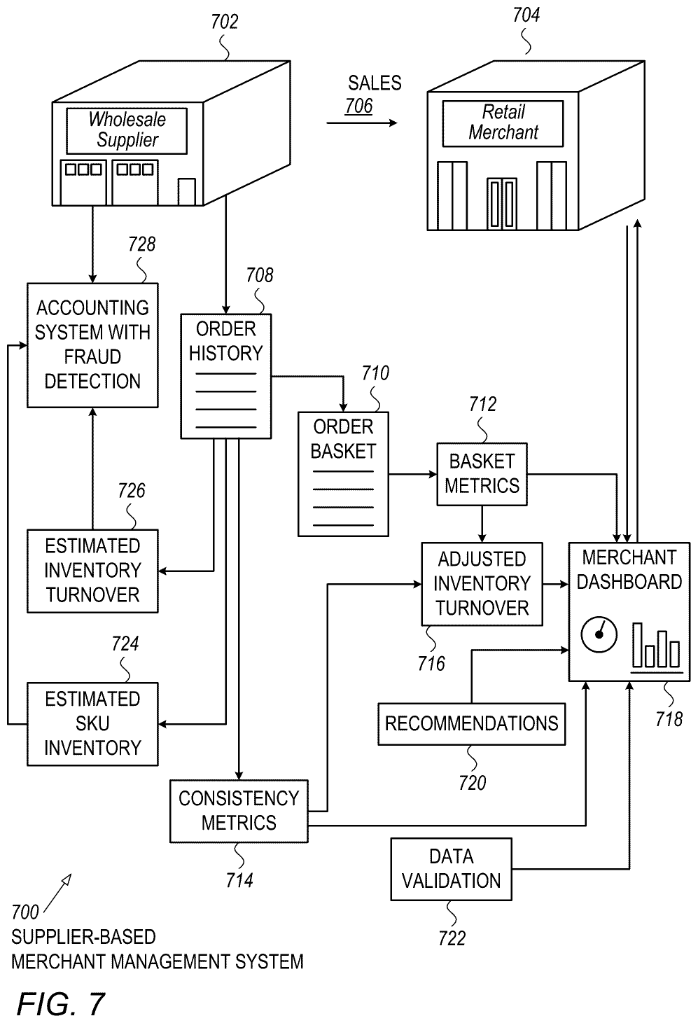

FIG. 7 is a diagram illustration showing an example embodiment 700 of a supplier-based merchant management system. A wholesale supplier 702 sells to a retail merchant 704 on a periodic basis. These sales 706 are known to the supplier 702, however, the supplier 702 may not have access to sales information by the merchant 704.

Nonetheless, an order history 708 for the order baskets 710 sold by the supplier 702 to the merchant 704 can be the basis for estimating performance metrics for the merchant 704. These performance metrics may allow the merchant 704 to monitor their business performance, and may also be used by the supplier 702 to recommend products or changes to the baskets to help the retail merchant 704 be more successful.

From each order basket 710, various basket metrics 712 may be computed. These metrics may include the SKU diversity, SKU entropy, SKU variety, SKU concentration, and the like. Additionally, various consistency metrics 714, such as basket consistency and basket variability may be computed. The consistency metrics 714 may analyze how baskets may change over time.

The order history 708 may reflect the merchant's business operations. As a merchant purchases items again and again, an analysis may assume that the merchant has successfully sold those items. An analysis of the growth, stagnation, or decline of those sales over time may reflect the merchant's business growth, stagnation, or decline.

Because the supplier 702 may have many order histories 708 from many different merchants 704, the supplier's data may be instructive to assist merchants to find improved mix of SKUs that may help the merchant increase sales.

Many of the metrics calculated from the supplier's order history 708 may be presented in a merchant dashboard 718. The merchant dashboard 718 may be a computer interface through which the merchant 704 may access at least some of the metrics observed or implied from the baskets of SKUs purchased from the supplier 702.

The merchant dashboard 718 may be part of a larger application or computerized system for the merchant. Such a system may allow a merchant to place orders through a computerized interface, apply for financing or negotiate payment terms, or facilitate other interactions between the merchant 704 and supplier 702.

Additionally, a supplier 702 may provide recommendations 720 to the merchant 704 for current or future purchases. The recommendations 720 may be provided during the ordering process or at other times.

Because the supplier's data may be based solely on the order history 708, data validation 722 may ask various questions of the merchant 704 to update a model of the merchant's business performance. The data validation 722 may supplement the supplier's data by querying a merchant 704 about certain SKUs, for example. In one such example, the data validation 722 may ask the merchant 704 whether the stock of a specific SKU has run out. If the stock has not run out, the data validation 722 may ask how many items are still on the shelf.

The data validation 722 may cause the underlying assumptions to the various business models to be adjusted. One assumption, for example, in a baseline analysis is that a merchant 104 may order a SKU after that SKU has been depleted to zero items. However, some merchants may attempt to keep a minimum number of inventory on the shelf at any time. By analyzing the merchant's specific behavior, the mathematical models may be updated and may be more closely tailored to that specific merchant.

By using solely the order history 708, various estimated metrics may be generated about the business performance of the supplier 702. These estimated metrics may include estimated SKU inventory 724 as well as estimated inventory turnover 726, as described above.

These metrics may be compared against other accounting systems 728, which may help identify fraud, excess shrinkage, theft, or other abnormalities. Metrics generated from a conventional accounting system 728 may be validated, or not, by comparing to estimated metrics that may be generated merely from the sales data. When the estimated metrics are consistent with comparable metrics in a conventional accounting system, the conventional accounting system may be trusted.

Similarly, when the estimated metrics may be outside a predefined threshold, an alarm, alert, or other action may be taken. A discrepancy outside of a predefined threshold may indicate an accounting irregularity that may be investigated and tracked down. In many companies, a conventional accounting system may be trusted by default. One mechanism to validate conventional accounting systems may be to compare against estimated metrics that may be computed from solely the sales data.

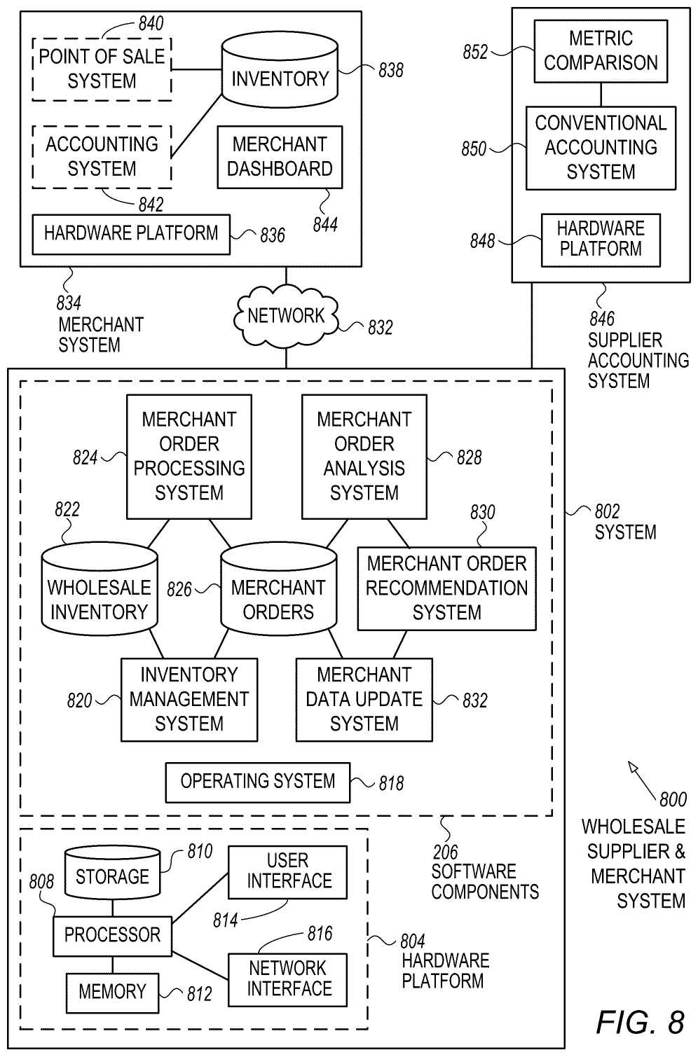

FIG. 8 is a diagram of an embodiment 800 showing components that may collect and analyze merchant purchase behavior to determine recommendations and provide a dashboard for merchants. The data may reflect baskets of goods purchased by a merchant from a supplier, and the supplier's records over time may provide useful information to the merchant. A system 802 may reflect an example system that may be operated by a wholesale supplier.

The diagram of FIG. 8 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 800 illustrates a device 802 that may have a hardware platform 804 and various software components. The device 802 as illustrated represents a conventional computing device, although other embodiments may have different configurations, architectures, or components.

In many embodiments, the device 802 may be a server computer. In some embodiments, the device 802 may still also be a desktop computer, laptop computer, netbook computer, tablet or slate computer, wireless handset, cellular telephone, game console or any other type of computing device. In some embodiments, the device 802 may be implemented on a cluster of computing devices, which may be a group of physical or virtual machines.

The hardware platform 804 may include a processor 808, random access memory 810, and nonvolatile storage 812. The hardware platform 804 may also include a user interface 814 and network interface 816.

The random access memory 810 may be storage that contains data objects and executable code that can be quickly accessed by the processors 808. In many embodiments, the random access memory 810 may have a high-speed bus connecting the memory 810 to the processors 808.

The nonvolatile storage 812 may be storage that persists after the device 802 is shut down. The nonvolatile storage 812 may be any type of storage device, including hard disk, solid state memory devices, magnetic tape, optical storage, or other type of storage. The nonvolatile storage 812 may be read only or read/write capable. In some embodiments, the nonvolatile storage 812 may be cloud based, network storage, or other storage that may be accessed over a network connection.

The user interface 814 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 816 may be any type of connection to another computer. In many embodiments, the network interface 816 may be a wired Ethernet connection. Other embodiments may include wired or wireless connections over various communication protocols.

The software components 806 may include an operating system 818 on which various software components and services may operate.

A supplier's system 802 may have an inventory management system 820, which may manage the wholesale inventory 822 of the supplier. The inventory management system 820 may keep a count of current inventory by adding items into inventory as they are purchased or received, then decrementing items as they are sold to a merchant.

A merchant ordering system 824 may be a computerized interface through which a merchant may place an order with the supplier. In many cases, a computerized interface may list items available for purchase, and a merchant may indicate which items to purchase and the quantity of those items. The merchant ordering system 824 may create a basket of items, which may be pulled from physical inventory and prepared for the merchant.

In some cases, the merchant ordering system 824 may be a point of sale system. In such cases, a merchant may purchase items at the supplier's warehouse on the spot, without pre-ordering. In such cases, the merchant's order may be assembled and items being sold may be entered into a merchant order system 824 as those items are requested.

A database of merchant orders 826 may be created over time. Each merchant may place orders for baskets of SKUs, and the frequency of orders and the repeated nature of the orders may be analyzed to determine the merchant's successfulness. Such analysis may be performed by a merchant order analysis system 828.

A merchant order analysis system 828 may analyze merchant orders to characterize individual baskets of SKUs, as well as analyze the orders over time. The basket characterization may include SKU diversity and the like, and over time, metrics for how those baskets change will also be generated.

The merchant order analysis system 828 may analyze merchant orders from many different merchants. A single supplier may provide goods for many different merchants, and sometimes a single supplier may sell to hundreds or even thousands of merchants.

In many instances, a merchant order analysis system 828 may compare one merchant's order history to many other merchant's order history. Such a database may be a rich source of information for comparison and learning.

A merchant order recommendation system 830 may make recommendations to a merchant regarding the basket composition. The recommendation system 830 may identify SKUs that are not good performers and may recommend eliminating, replacing, or purchasing a smaller quantity of the SKU. In some cases, the recommendation system 830 may suggest an alternative SKU that may have been successful with other merchants.

The merchant order recommendation system 830 may suggest additional SKUs that have been successful with other merchants. One mechanism for such a recommendation is to find a similar merchant and to analyze the differences in SKUs between their baskets.

The similarity between one merchant and another may be based on their order history, quantity sold, frequency of replenishment, or other factors. Once a similar merchant may be identified, a recommendation system 830 may identify a particular SKU that the similar merchant has shown success in selling. A more strongly recommended item may have a high profit margin, high selling volume, or other economic factor by which the new SKU may be attractive.

A merchant data update system 831 may query a merchant on one or more data items. These updates may be used to update the merchant's business statistics as well as to refine the assumptions made while analyzing the merchant's business. For example, one assumption may be that a merchant orders a SKU the instant after selling the full amount in inventory. Such an assumption does not reflect reality, but the assumption simplifies the math. For example, using such an assumption, the merchant order analysis system 828 may calculate the average number of sales of a SKU per day as being the quantity purchased from the supplier divided by the number of days between orders.

In the example, the merchant may have sold out of an item very quickly, but operated with zero inventory for several days before placing a replenishment order. The merchant data update system 831 may ask the merchant directly if the SKU has sold out and when that occurred. In some cases, a merchant may order replenishment prior to running out of the product. In such a case, the merchant data update system 831 may ask the merchant to report the inventory at hand when they placed a new order.

The example is merely one use case for the merchant data update system 831. The merchant data update system 831 may identify questions to periodically ask of the merchant. Such questions may help a supplier update their model of a merchant's ordering and selling behavior.

A network 832 may connect a supplier's system 802 with a merchant system 834.

The merchant system 834 may operate on a hardware platform 836 and may include an inventory database 838, a point of sale system 840, and an accounting system 842. Some merchants may operate using a physical inventory system, meaning that they may keep pen and paper records of inventory, or they may merely look at the shelves to see how much product is available. Other merchants may have an automated or semi-automated system that checks in new inventory when received, and decrements inventory that may be sold. Some merchants may have an automated or computerized accounting system 842, which may track sales over time.

In some use cases, a merchant system 834 may be connected to a supplier system 802 to transfer point of sale data or accounting data to the supplier. Such a data transfer may be possible with sophisticated merchants that have computerized infrastructure. For many smaller merchants, such systems may not be available or useful.

A merchant dashboard 844 may be a user interface through which a merchant may view data and recommendations provided by the supplier system 802. The merchant dashboard 844 may include other features, such as an order placement system as well. In many cases, the merchant dashboard 844 may be a mechanism to communicate between a merchant and supplier, and two-way communications may be possible, such as with the merchant data update system 831 or other uses.

A supplier accounting system 846 may operate on a hardware platform 848 and have a conventional accounting system 850. The conventional accounting system 850 may take data from many sources, including sales data, inventory data, accounts payable, accounts receivable, banking information, and other sources.

In many cases, such accounting systems may be complex and may be accessed by a limited number of highly trained bookkeepers and accountants. Such a situation may place a great amount of trust or reliance on those people.

By independently calculating business metrics from sales data alone, the results of a conventional accounting system 850 may be validated. A metric comparison 852 may compare expected or estimated metrics from merchant purchases against the records of the conventional accounting system 850. When the estimated metrics and the conventional accounting system do not agree, an investigation may be warranted to find the source of the discrepancy. Such discrepancies may be difficult to detect without using metrics estimated solely from the supplier's sales data.

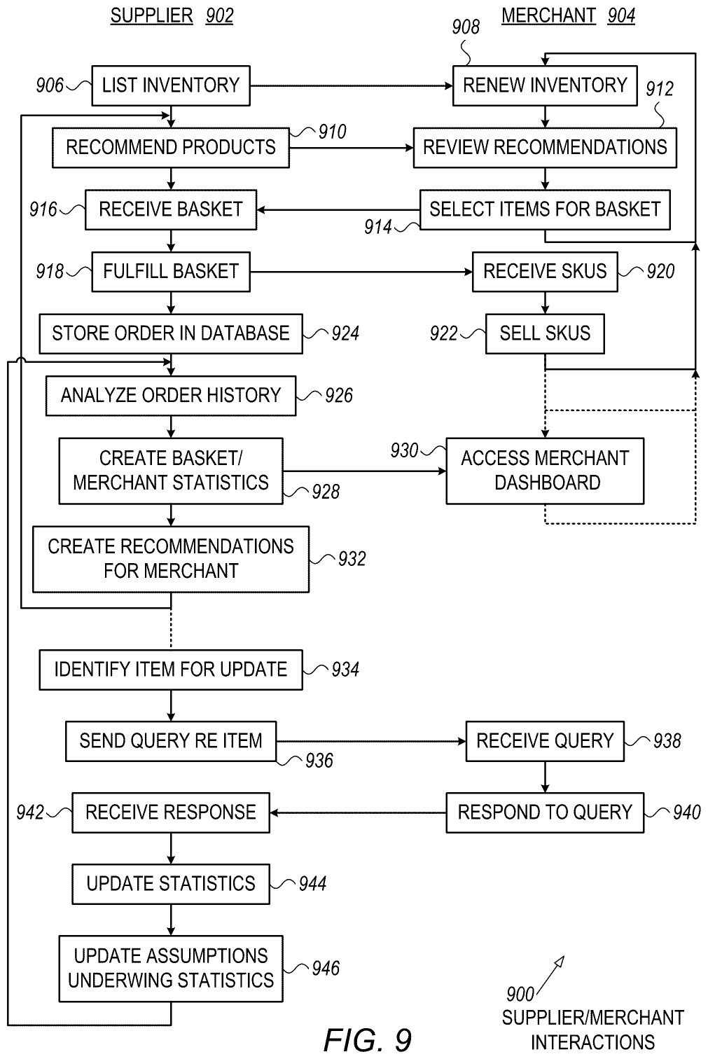

FIG. 9 is a flowchart illustration of an embodiment 900 showing a method of interacting between a supplier 902, shown on the left hand column, and a merchant 904, shown in the right hand column. The illustrated interactions represent typical functions that may be performed to track a merchant's order, as well as to make recommendations to the merchant and update data items for the supplier.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

The method of embodiment 900 may show a typical interaction where a supplier may offer items for sale and a merchant may select items. A history of sales from the merchant, as well as history of sales from other merchants, may be used to recommend changes to the merchant's baskets.

A supplier 902 may list inventory available on block 906, which a merchant 904 may review in block 908. The supplier 902 may also recommend products in block 910, which the merchant 904 may review in block 912. After reviewing the available inventory in block 908 and recommendations in block 912, the merchant 904 may select items for their basket in block 914.

The basket, as used here and other places in this specification and claims, refers to a single purchase of a retail merchant from a wholesale supplier. For some merchants, baskets of goods may be purchased daily, weekly, bi-weekly, monthly, or some other period. Some merchants may schedule basket purchases on another cadence, while some may purchase baskets of goods based on low inventory or other basis, and such purchases may be done on non-regular intervals.

The supplier 902 may fulfil the basket in block 918, and the merchant 904 may receive the SKUs in block 920 and proceed to sell the SKUs in block 922.

As the merchant 904 runs low on inventory or runs out of inventory, the merchant 904 may return to block 908 to make another purchase from the supplier.

The supplier 902 may store the order in a database in block 924. The order history may be analyzed in block 926 to create basket and merchant statistics in block 928. Some or all of the statistics may be made available to the merchant in block 930.

Based on the statistics and order history, the supplier 902 may create recommendations for the merchant in block 932. The recommendations may be fed back to block 910 for the next purchase cycle. In some cases, recommendations may be made through the merchant's dashboard. In such cases, the merchant's dashboard may be part of an application or computer interface through which purchases may be pre-ordered. Such applications or computer interfaces may provide other functionality as well.

The supplier 902 may be creating statistics and estimations of a merchant's business performance using incomplete data. Specifically, the supplier has data relating to the purchases made by the merchant, but does not have visibility into the merchant's actual sales.

An example is that the supplier estimates actual retail sales based on the merchant's re-purchase behavior of a SKU. In the example, two merchants may repurchase 100 of that SKU every week, and the supplier's statistics may show identical business performance. However, one merchant may sell out of the 100 units of the SKU in three days, while the other merchant may have an inventory of 10 units on hand at the end of the week when they reorder.

In the example, the first merchant may be better off ordering additional units of the SKU because their sales can support a higher level. The second merchant may order fewer units of the same SKU because their inventory carrying costs reduce business performance. Even though both merchants appear to be the same from the supplier's order history, the supplier may be able to assist the merchants through a recommendation system when the supplier has better insight and better data underlying the assumptions about the merchant's business performance.

A supplier 902 may request data from the merchant 904 to feedback into the statistics and business performance analysis for the merchant. The request may be simple questions about individual SKUs, about weekly/monthly/yearly sales, inventory management, or any other topic. A simple question may be similar to how long did it take to sell out of SKU? Another example may be how much of SKU did you have on hand last time you ordered?

In some cases, the queries may be more comprehensive or detailed. For example, an update may ask the merchant to list their current inventory on a basket of SKUs.

The data received from the merchant may help the supplier to update their statistics about the merchant's performance, as well as update the recommendations made to the merchant.

The supplier 934 may identify an item to update in block 934. A query may be sent in block 936, which may be received by the merchant 904 in block 938. The merchant 904 may respond to the query in block 940, and the response may be received in block 942. The supplier's statistics for the merchant may be updated in block 944, and any assumptions underlying the statistics may be updated in block 946. The statistics may be fed back to block 926, where the statistics may be updated.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
electronic access to a supplier database comprising historical sales data from a first supplier to a first merchant;
at least one processor, said at least one processor configured to perform a method comprising:
receiving a first series of sales to a first merchant from said supplier database;
analyzing said first series of sales to said first merchant to determine a set of basket features for each of said sales in said first series of sales to said first merchant;
receiving a first set of know your customer features;
receiving a request for a first loan for said first merchant, said request comprising a loan amount;
determining a first confidence score for said first loan by analyzing said loan amount, said know your customer features, and said set of basket features to generate said first confidence score; and
determining that said first confidence score is above a first threshold and offering said first loan to said first merchant.

2. The system of claim 1 further comprising:
electronic access to a mobility database comprising historical location information for a first device related to said first merchant;
said method further comprising:
receiving a first series of historical location information from said mobility database;
analyzing said first series of historical location information to determine a set of mobility features for said first device;
receiving said set of mobility features; and
said first confidence score being additionally determined using said set of mobility features.

3. The system of claim 2, said mobility features comprising at least one of a group composed of:
radius of gyration;
random entropy;
uncorrelated entropy;
real entropy;
jump lengths; and
maximum distance.

4. The system of claim 3, said mobility database being generated at least in part by monitoring a first mobile device associated with said first merchant.

5. The system of claim 4, said monitoring being performed by an application operating on said first mobile device.

6. The system of claim 4, said monitoring being performed by a mobile service provider.

7. The system of claim 6, said first merchant having given permission to said system to access said mobility database.

8. The system of claim 4, said monitoring further being performed by an application operating on a second mobile device.

9. The system of claim 1, said basket of features comprising at least one of a group composed of:
inventory turnover;
revenue history; and
average purchase amount.

10. A system comprising:
electronic access to a mobility database comprising historical location information for a first device related to said first merchant;
at least one processor, said at least one processor configured to perform a method comprising:
receiving a first series of historical location information from said mobility database;
analyzing said first series of historical location information to determine a set of mobility features for said first device;
receiving a request for a first loan for said first merchant, said request comprising a loan amount;
determining a first confidence score for said first loan by analyzing said loan amount and said set of mobility features to generate said first confidence score; and
determining that said first confidence score is above a first threshold and offering said first loan to said first merchant.

11. The system of claim 10 further comprising:
electronic access to a supplier database comprising historical sales data from a first supplier to a said method further comprising:
receiving a first series of sales to said first merchant from said supplier database;
analyzing said first series of sales to said first merchant to determine a set of basket features for each of said sales in said first series of sales to said first merchant;
receiving said first set of basket features; and
said first confidence score being additionally determined using said set of basket features.

12. The system of claim 11, said basket of features comprising at least one of a group composed of:
inventory turnover;
revenue history; and
average purchase amount.

13. The system of claim 10, said mobility features comprising at least one of a group composed of:
radius of gyration;
random entropy;
uncorrelated entropy;
real entropy;
jump lengths; and
maximum distance.

14. The system of claim 13, said mobility database being generated at least in part by monitoring a first mobile device associated with said first merchant.

15. The system of claim 14, said monitoring being performed by an application operating on said first mobile device.

16. The system of claim 14, said monitoring being performed by a mobile service provider.

17. The system of claim 16, said first merchant having given permission to said system to access said mobility database.

18. The system of claim 14, said monitoring further being performed by an application operating on a second mobile device.

19. A system comprising:
electronic access to a mobility database comprising historical location information for a first device related to said first merchant;
electronic access to a supplier database comprising historical sales data from a first supplier to a at least one processor, said at least one processor configured to perform a method comprising:
receiving a first series of historical location information from said mobility database;
analyzing said first series of historical location information to determine a set of mobility features for said first device;
receiving a first series of sales to said first merchant from said supplier database;
analyzing said first series of sales to said first merchant to determine a set of basket features for each of said sales in said first series of sales to said first merchant;
receiving a request for a first loan for said first merchant, said request comprising a loan amount;
determining a first confidence score for said first loan by analyzing said loan amount, said set of basket features, and said set of mobility features to generate said first confidence score; and
determining that said first confidence score is above a first threshold and offering said first loan to said first merchant.

20. The system of claim 19
said basket of features comprising at least one of a group composed of:
inventory turnover;
revenue history; and
average purchase amount; and
said mobility features comprising at least one of a group composed of:
radius of gyration;
random entropy;
uncorrelated entropy;
real entropy;
jump lengths; and
maximum distance.
